(19) United States
(12) Patent Application Publication
(10) Pub. No.: US 2008/0088209 A1
(43) Pub. Date: Apr. 17, 2008

(54) Stepping Motor

(76) Inventor: IN SOOL RYU, Gwangsan-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/873,111

(22) Filed: Oct. 16, 2007

(30) Foreign Application Priority Data
Oct. 16, 2006 (KR) 10-2006-0100356

(51) Int. Cl. H02K 37/12; H02K 5/00

(52) U.S. Cl. 310/49 R; 310/89; 310/91

(57) ABSTRACT

A stepping motor is provided. The stepping motor comprises a bracket, a lead screw having a first side rotatably supported by the bracket, and a housing. A second side of the lead screw is disposed in the housing such that the lead screw is rotatably supported thereto, and a portion of the bracket is inserted into the housing so as to be coupled with the housing. A stator is installed in the housing, and a rotor is coupled with the lead screw to interact with the stator for rotating the lead screw.

### CROSS-REFERENCE TO RELATED APPLICATION

The present application claims the benefit under 35 U.S.C. §119 of Korean Patent Application No. 10-2006-0100356, filed Oct. 16, 2006, which is hereby incorporated by reference in its entirety.

### BACKGROUND

A stepping motor is a rotor that rotates at a predetermined angle when external DC voltage or DC current is applied to each phase terminal of the motor in a switching scheme.

The stepping motor is a digitally controlled device which is suitable for a digital pulse type control, other than analog power control.

A stepping motor performs rotational movement precisely by a rotation angle corresponding to an input digital pulse.

### BRIEF SUMMARY

The subject disclosure provides a stepping motor.

An embodiment of the present invention provides a stepping motor capable of increasing a coupling strength between a bracket and a housing.

A stepping motor according to an embodiment comprises a bracket, a lead screw having a first side rotatably supported by the bracket, a housing, in which a second side of the lead screw is disposed such that the lead screw is rotatably supported thereto and into which a portion of the bracket is inserted so as to be coupled with the housing, a stator installed in the housing, and a rotor coupled with the lead screw to interact with the stator for rotating the lead screw.

A stepping motor according to one embodiment comprises a bracket including a base bracket and first and second side brackets obtained by vertically bending both ends of the base bracket, a lead screw having a first portion rotatably supported by the second side bracket and a second portion positioned at an outer side of the bracket by passing through the first side bracket, a housing, in which the second side of the lead screw is disposed such that the lead screw is rotatably supported thereto and into which the first side bracket is inserted, a stator installed in the housing, and a rotor coupled to the lead screw to interact with the stator for rotating the lead screw.

### BRIEF DESCRIPTION OF THE DRAWINGS

FIG. 1 is an exploded perspective view representing a stepping motor according to an embodiment of the present invention.

FIG. 2 is an assembled perspective view representing the stepping motor according to an embodiment of the present invention.

FIG. 3 is a sectional view representing the stepping motor according to an embodiment of the present invention.

### DETAILED DESCRIPTION

Hereinafter, a stepping motor according to an embodiment of the present invention will be described in detail with reference to accompanying drawings.

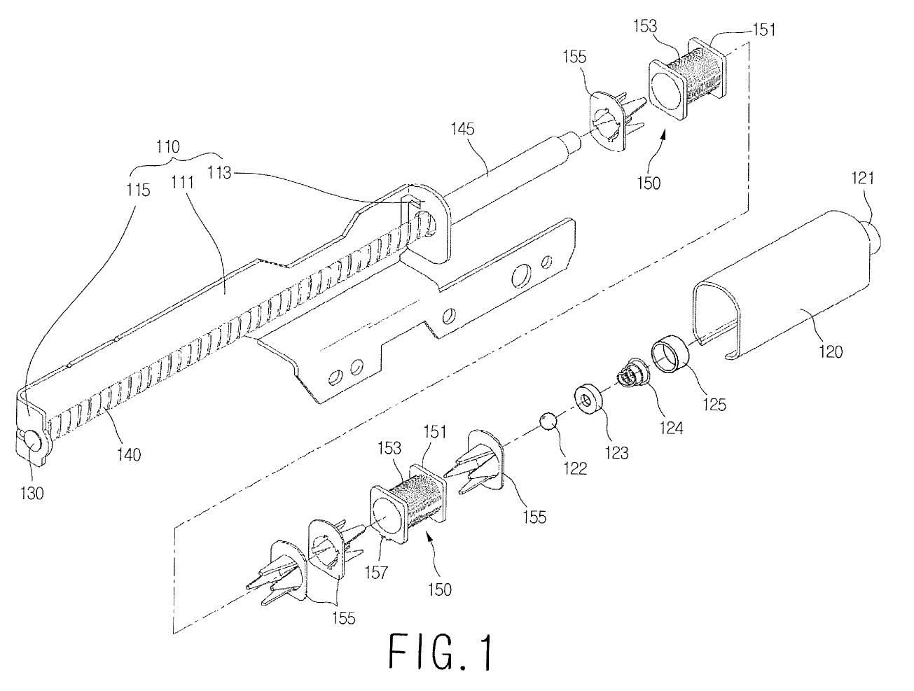

Referring to FIGS. 1 to 3, a stepping motor comprises a bracket 110 including a base bracket 111, a first side bracket 113 and a second side bracket 115. The first side bracket 113 and the second side bracket 115 can be formed by vertically bending both ends of the base bracket 111.

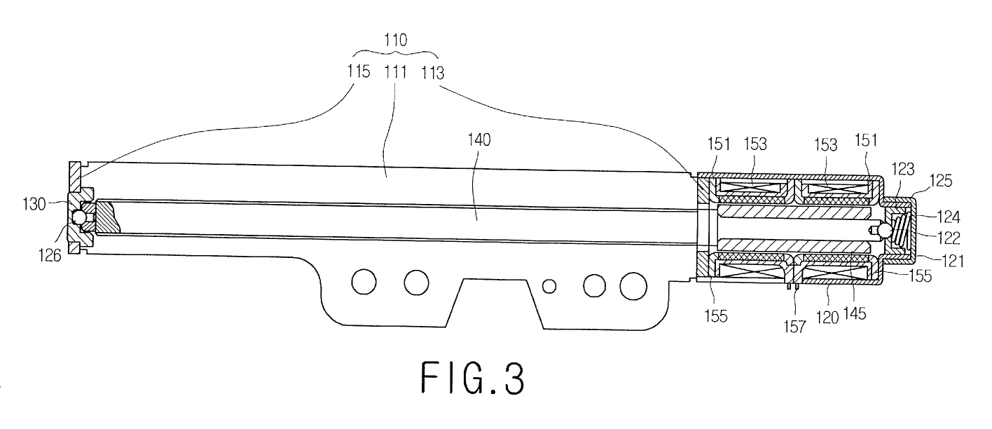

A pivot bearing 130 is coupled to the second side bracket 115, and as shown in FIG. 3, one side of a first ball bearing 126 can be inserted into the pivot bearing 130. One end of a lead screw 140 is inserted into the other side of the first ball bearing 126, such that the first ball bearing 126 rotatably supports the lead screw 140.

The other end of the lead screw 140 is positioned at the outer side of the bracket 110 by passing through the first side bracket 113.

A magnet 145 having a ring-shaped section is inserted into the lead screw 140 located at the outer side of the bracket 110, such that the magnet 145 can be fixed to the lead screw 140.

A cylindrical housing 120 can be coupled with the first side bracket 113. One side of the housing 120 is open, and the opening side of the housing 120 can be coupled to the first side bracket 113 by means of welding.

A protruding tube 121 is formed at the other side of the housing 120. The lead screw 140 is able to rotate while being elastically supported by the protruding tube 121.

A second ball bearing 122 coupled with the lead screw 140, a thrust holder 123 coupled with the second ball bearing 122, an elastic member 124 elastically supporting the thrust holder 123 and an end cover 125 supporting the elastic member can be installed in the protruding tube 121.

The elastic member 124 can include a conical coil spring. A small-diameter portion of the spring retracts into a large-diameter portion of the spring when the conical coil spring is compressed, so that components of the spring do not collide with each other, thereby reducing the noise.

In addition, a stator 150 is installed in the housing 120 such that the stator 150 surrounds the magnet 145.

The stator 150 can include bobbins 151 installed in the housing 120, a coil 153 wound around the outer circumferential surface of each bobbin 151 and metal tooth yokes 155 inserted into opposite sides of the bobbin 151, respectively. In one embodiment, the stator 150 can have a two bobbin configuration as shown in FIGS. 1 and 3.

Accordingly, as current is selectively supplied to the coil 153, the magnet 145 rotates forward or backward by an interaction between an electric field and a magnetic field, which are generated from the coil 153 and the magnet 145, respectively. For this reason, the lead screw 140 rotates forward or backward, so that an element coupled with the lead screw 140 linearly reciprocates.

For example, an optical pickup can be coupled with the lead screw 140, thereby performing a reciprocating motion to reproduce information from a disk or record information on the disk.

In the stepping motor according to embodiments of the present invention, the first side bracket 113 of the bracket 110 is inserted into the housing 120 and is welded to the housing 120, so that the bracket 110 is coupled to the housing 120.

One side of the housing 120 is open and the housing has a cross-sectional shape corresponding to the shape of the first side bracket 113. The first side bracket 113 is inserted into the opening side of the housing 120 such that the outer circumferential surface of the first side bracket 113 makes contact with the inner circumferential surface of the housing 120. In this state, the housing 120 can be laser-welded at several portions in the outer circumferential surface thereof, so that the housing 120 melts and is integrally coupled to the first side bracket 113.

The housing 120 can include a first material and the first side bracket 113 can include a second material. For example, the housing 120 can be formed of a cold rolled steel plate that is heat-treated in a hydrogen atmosphere to have advantages for a magnetic circuit. In addition, the first side bracket 113 can be formed of a cold rolled steel plate that is coated with zinc.

If the first material of the housing 120 is different from the second material of the first side bracket 113, the housing 120 and the first side bracket 113, when disposed in parallel or next to each other, may not be welded properly because the first and second materials have different melting points. Therefore, when the housing 120 and the first side bracket 113 are disposed side by side in parallel with each other, the coupling strength may be deteriorated.

For this reason, according to embodiments of the present invention, the first side bracket 113 is disposed in the housing 120 instead of parallel to the housing 120. Therefore, the housing 120 melts to be coupled to the first side bracket 113, thereby obtaining the higher coupling strength as compared with the case in which the housing 120 and the first side bracket 113 are welded to each other in a state in which they are disposed side by side.

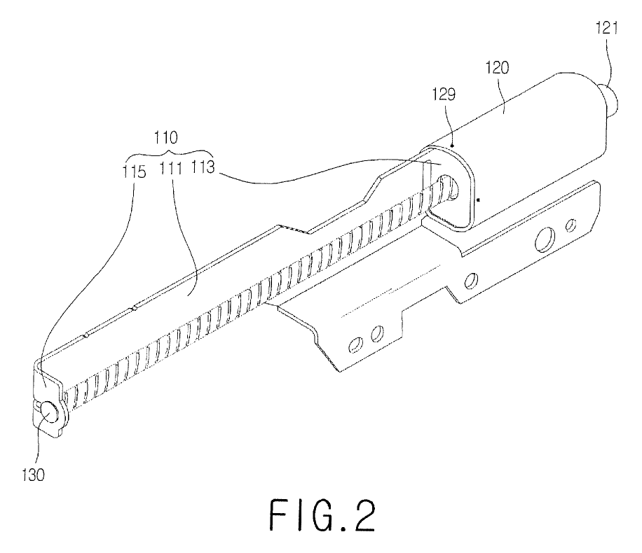

FIG. 2 shows welding spots 129 formed at the outer surface of the housing 120.

According to the stepping motor of embodiments of the present invention, the outer surface of the housing 120 is welded, thereby coupling the first side bracket 113, which is inserted in the housing 120, with the housing 120. That is, only the housing 120 is welded, so that a uniform welding is obtained, thereby enhancing the coupling strength between the bracket 110 and the housing 120.

According to the stepping motor of an embodiment of the present invention, the first side bracket 113 is inserted into the housing 120, and the outer surface of the housing 120 is laser-welded. Accordingly, the welded portions of the housing 120 melt, so that the housing 120 is integrally coupled with the first side bracket 113.

That is, since welding work can be performed by melting only the housing 120, uniform welding is obtained. Thus, the coupling strength between the first side bracket 113 and the housing 120 can be enhanced.

In addition, since uniform welding is obtained, the number of welding portions is reduced, facilitating coupling work between the bracket 110 and the housing 120.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A stepping motor comprising:
a bracket;
a lead screw having a first side rotatably supported by the bracket;
a housing, in which a second side of the lead screw is disposed such that the lead screw is rotatably supported thereto and into which a portion of the bracket is inserted so as to be coupled with the housing;
a stator installed in the housing; and
a rotor which is coupled with the lead screw to interact with the stator for rotating the lead screw.

2. The stepping motor according to claim 1, wherein the second side of the lead screw is positioned at an outer side of the bracket by passing through the bracket.

3. The stepping motor according to claim 1, wherein the bracket and the housing are coupled to each other by a laser welding.

4. The stepping motor according to claim 1, wherein the bracket makes contact with an inner surface of the housing when the bracket is coupled with the housing.

5. The stepping motor according to claim 1, wherein a welding spot is formed at an outer surface of the housing.

6. The stepping motor according to claim 1, wherein the housing includes a first material and the bracket includes a second material different from the first material.

7. The stepping motor according to claim 6, wherein the first material comprises a cold rolled steel plate heat-treated in a hydrogen atmosphere, and wherein the second material comprises a cold rolled steel plate coated with zinc.

8. A stepping motor comprising:
a bracket comprising a base bracket, a first side bracket, and a second side bracket, wherein the first side bracket and the second side bracket are obtained by bending both ends of the base bracket;
a lead screw having a first portion rotatably supported by the second side bracket and a second portion positioned at an outer side of the bracket by passing through the first side bracket;
a housing, in which the second portion of the lead screw is disposed such that the lead screw is rotatably supported thereto and into which the first side bracket is inserted;
a stator installed in the housing; and
a rotor coupled to the lead screw to interact with the stator for rotating the lead screw.

9. The stepping motor according to claim 8, wherein the stator comprises a bobbin, a coil wound around the bobbin and a tooth yoke inserted into the bobbin, and wherein the rotor comprises a magnet.

10. The stepping motor according to claim 8, wherein an inner surface of the housing is melted, coupling the first side bracket to the housing.

11. The stepping motor according to claim 8, wherein the housing includes a first material and the first side plate bracket includes a second material different from the first material.

12. The stepping motor according to claim 11, wherein the first material comprises a cold rolled steel plate heat-treated in a hydrogen atmosphere, and wherein the second material comprises a cold rolled steel plate coated with zinc.
